(19) United States
(12) Patent Application Publication
(10) Pub. No.: US 2022/0304499 A1
(43) Pub. Date: Sep. 29, 2022

(54) BEVERAGE PREPARATION MACHINES AND METHODS OF CONNECTING STEAM WANDS THERETO

(71) Applicant: Koninklijke Douwe Egberts B.V., Utrecht (NL)

(72) Inventors: Nicholas Hansen, Banbury (GB); Harrison Lloyd Woodall, Banbury (GB); Marko Plevnik, London (GB)

(21) Appl. No.: 17/617,920

(22) PCT Filed: Jun. 10, 2020
(86) PCT No.: PCT/EP2020/066090

§ 371 Date: Dec. 9, 2021

(30) Foreign Application Priority Data
Jun. 14, 2019 (GB) 1908557.0

(51) Int. Cl. A47J 31/44

(52) U.S. Cl. CPC A47J 31/4489; A47J 31/4403

(57) ABSTRACT

The invention provides a beverage preparation machine comprising a steam wand connector wherein the connector comprises an aperture having a first portion having a first maximum width which tapers and/or curves to a second portion which has a second narrower width.

### TECHNICAL FIELD OF THE INVENTION

The present invention relates to beverage preparation machines and systems comprising a beverage preparation machine and a steam wand. The invention further relates to methods of attaching a steam wand to a beverage preparation machine and to steam wands.

### BACKGROUND TO THE INVENTION

Beverage preparation machines, such as coffee machines, are known to be provided with frothing systems with which a milk container can be associated for warming and/or frothing a milk beverage. The increasing demand from consumers for the consumption of coffee preparations including a layer of frothed milk, such as, for example, cappuccino, macchiato, flat white and/or latte, has directed the coffee industry to focus on developing new and/or improved frothing systems.

A layer of foam improves the appeal of the beverage preparation, resulting in a better experience for consumers and a higher customer satisfaction.

In known frothing systems, heating and frothing is usually provided via a flow or jet of steam which is sent into the milk container through a steam wand (also called a froth wand), to warm and emulsify the milk beverage.

The steam wand is typically an elongate member which in use extends into a cup or other container in which the beverage is to be heated and frothed. The wand has a steam conduit through which steam is passed from an inlet end of the wand connected to a steam supply in the beverage preparation apparatus, which steam then travels to an outlet end of the wand, configured to eject the steam into the beverage.

Such a system is known for example from US-A1-2003/0131735 in which the wand includes a generally tubular external sleeve and an inner core within the external sleeve. The inner core defines the steam conduit and the wand further includes a coupling mechanism to facilitate connection of the wand to a steam supply of a beverage preparation device. The coupling mechanism may include threads, clamps, grooves, quick connect mechanisms, or other suitable fasteners complementarily configured to connect with the steam supply and allow for de-coupling and re-coupling of the wand from the steam supply to facilitate maintenance and cleaning. The external sleeve may be removed for cleaning and repair. For example, the external sleeve may be removed after a beverage of one flavour is prepared, so as to minimize the risk of imparting an undesired flavour to a subsequently prepared beverage. In addition, several different external sleeves individually configured to accommodate specific functions may be interchangeably coupled to the wand core, thus diversifying the utility of the wand.

It is desirable from a hygienic point of view that the wand is de-coupled, cleaned and re-coupled after each use. However, in the system known from US-A1-2003/0131735, this process requires a lot of time, making it somewhat impractical, with the result that users of the system frequently refrain from cleaning the wand after it has been used, which could lead to health risks. In addition, a contaminated wand may also contaminate the inside of the beverage preparation device, which internal contamination may be hard to remove.

To address some of the issues in the earlier system, WO2017/003289 A2 proposed a system in which the wand is disposable and in which it is easier and quicker to remove and replace the wand. The system includes a beverage preparation machine having a steam nozzle connected with a steam source and a wand holder in which a wand is removably received. The wand holder is manually movable between an operational position in which the steam nozzle is in fluid communication with a steam inlet of the wand and a non-operative position in which the wand can be inserted into or removed from the wand holder. In this arrangement, a used wand can be quickly and easily removed from the device by moving the wand holder to the non-operative position. The used wand can be discarded and replaced by a new wand.

The provision of disposable wands enables the system to be used in a very hygienic manner, while at the same time reducing the time required to change the wand since cleaning of a used wand can be dispensed with. Whilst this is an improvement on the system disclosed in US-A1-2003/0131735, there is an ongoing need to develop arrangements for mounting and de-mounting a wand to a beverage preparation machine which are simpler and more intuitive from an end user's perspective.

It would be therefore advantageous to provide a solution which mimics the behaviour of the known frothing systems, but enables an easy and intuitive insertion of a wand into a beverage preparation machine.

It would be furthermore advantageous to provide a solution which would provide an easy de-coupling of a wand from a beverage preparation machine.

Finally, it would be advantageous to provide a solution which does not require a careful alignment of a wand with a wand connector or holder when inserting said wand into a beverage preparation machine.

It is therefore an aim of embodiments of the invention to satisfy the highly-felt need of an easy-to-use foaming solution to overcome or mitigate at least one problem of the prior art whether disclosed herein or not.

### SUMMARY OF THE INVENTION

According to a first aspect of the invention there is provided a beverage preparation machine comprising a steam wand connector wherein the connector comprises an aperture having a first portion having a first maximum width which tapers and/or curves to a second portion which has a second narrower maximum width.

A connector aperture having a first larger portion and second narrower portion, and a curved or tapering join, enables the head of a steam wand with a bulbous head to be inserted into the first portion at many different angles, and then the curved/tapered join used to enable easy rotation and movement of the body of the steam wand into the second portion.

The first portion of the aperture may be at least 25%, 30%, 35%, 40%, 45% or at least 50% wider than the second portion. The first portion of the aperture preferably comprises a curved or rounded edge surrounding at least 75%, 80%, 85%, 90% or at least 95% of the first portion, more preferably substantially 100%.

In some embodiments, said first portion may be substantially circular, semi-circular, circular segment, circular cap, balloon-shaped or funnel-shaped in cross-section. The said second portion may have a slot, tubular or channel shape cross-section and may extend below said first portion. The second portion of the aperture may be open at its distal end. Thus, the second portion of the aperture may comprise an open-ended slot. In preferred embodiments the first portion may be substantially circular or balloon-shaped in cross-section, tapering to a second portion which has a slot or channel-shaped cross-section. By “balloon” shaped we mean a bulbous, rounded cap tapering to a narrower neck.

In some embodiments, the connector may directly or indirectly be in fluid communication with a steam source of the beverage preparation machine.

The aperture may be formed in a connector plate.

In some embodiments, the aperture may comprise a slot through the connector plate or be formed as an opening into a cavity (or pocket) formed in the connector plate. The cavity may comprise a cavity body open on one side to form the aperture.

Preferably said slot may comprise a keyhole shape or the cavity may comprise a keyhole cross-sectional shape. In some embodiments said first portion of the cavity may comprise a substantially spherical, hemispherical, spherical cap, part spherical, balloon or spherical segment shape and said second portion of the cavity may comprise a tubular or channel shape, such as a half-cylinder, preferably open at its distal end. In preferred embodiments the aperture comprises a cavity comprising a first portion which is substantially spherical, balloon, hemispherical, part spherical, spherical segment or spherical cap shaped (preferably substantially spherical, balloon-shaped or hemispherical), and which tapers to a second portion which comprises a channel (which may be U-shaped or semi-circular in cross-section, for example), more preferably a half-cylindrical shape, open at its distal, lower end.

In some embodiments the aperture is set back in the connector plate, such as formed in a pocket of the connector plate (preferably formed in the base of said pocket). In some embodiments the connector plate may comprise (preferably planar) top and left- and right-side walls, which taper inwardly to form a pocket defined therebetween, and the aperture may be formed in the base of the pocket.

The connector plate may be arranged on a front face of said beverage preparation machine, which may be in a position which is substantially above a final beverage container, in use.

The beverage preparation machine may be a coffee preparation machine.

The beverage preparation machine may comprise a steam outlet, which is indirectly or directly in fluid communication with the aperture of the connector plate. In some embodiments the steam outlet of the beverage preparation machine may extend at least partway into the aperture, in an operative position. In some embodiments the steam outlet may remain outside of the aperture in a non-operative position. An operative position may be a position in which steam is able to flow into the aperture or any steam wand connected to the aperture, in use. When the aperture comprises a cavity then the steam outlet of the beverage preparation machine may be moveable between an operative position in which it at least partly extends into the cavity, and a non-operative position in which it remains outside of the cavity. In other embodiments, the beverage preparation machine steam outlet remains stationary (e.g. is not moveable between two distinct positions), and any steam wand connected within the aperture (or cavity) of the connector plate may be moved between an operative position in which it is fluidly connected to the steam outlet, and a non-operative position in which it is disconnected from the steam outlet. In the non-operative position, the beverage preparation machine steam outlet may be closed such that no steam can flow therefrom. A steam wand connectable to the beverage preparation machine may comprise a steam conduit which runs through the steam wand and is configured to receive steam through a steam conduit opening in the head of the steam wand, and to convey, transport or guide said steam to the distal end of the steam wand, where it can be dispensed therefrom. The steam outlet of the beverage preparation machine and/or the steam wand head may be moved or moveable such that the steam outlet at least partially enters the steam conduit opening within the steam wand head, in use.

According to a second aspect of the invention there is provided a system comprising a beverage preparation machine of the first aspect of the invention and a steam wand, wherein the steam wand comprises a head and body, wherein the head is wider than the body and wherein a steam conduit extends through the head and body of said steam wand.

In preferred embodiments the width (or diameter) of the head is smaller than the width (or diameter) of the first portion of the connector, but wider than the width (or diameter) of the second portion, and the width (or diameter) of the body is smaller than the width (or diameter) of the second portion of the connector. In this way the wand head can be inserted into the first portion of the aperture of the connector, which head cannot pass through into the second portion of the aperture of the connector, but the body can then be manipulated such that at least a portion enters the second portion. The curved first portion enables the head to be inserted in many orientations and the body moved to fit into the second portion.

In some preferred embodiments, the head may have a substantially spherical, hemispherical, balloon, part spherical, spherical segment or spherical cap shape which may taper towards the body which may have a tubular, prismatic or channel shape, such as a cylinder. Furthermore, the first portion of the connector aperture may comprise a shape which may match the shape of the head, preferably a substantially spherical or balloon shape. The second portion of the connector aperture may have a tubular, prismatic or channel shape, or a semi-tubular, semi-prismatic or semi-channel shape which may match or be complimentary to the shape of the body of the steam wand. The second portion may be open at its distal end to allow the steam wand body to extend out of the aperture

In some embodiments, the head may be integral with, attached to or detachable from, the body.

In some embodiments, said steam wand further may comprise a handle.

In some embodiments, the handle may be attached to, attachable to, detachable from or integral with said head or said body.

According to a third aspect of the invention there is provided a method of attaching a steam wand to a beverage preparation machine of the first aspect of the invention, comprising the steps of:

providing a steam wand having a head and body, wherein the head is wider than the body and wherein a steam conduit extends through the head and body of said steam wand; and
introducing the steam wand head into the first portion of the beverage preparation machine connector aperture; and orienting the wand body into the second portion of the beverage preparation machine connector aperture.

The steam wand may be as described hereinabove in relation to the second aspect of the invention, and all embodiments or combinations of embodiments may be independently used.

According to a fourth aspect of the invention there is provided a steam wand comprising a head having a first maximum width which tapers and/or curves to a body which has a second narrower width, and wherein the head and body comprise a steam conduit running therethrough, having a steam inlet in the head and a steam outlet in the body.

The head may be substantially spherical, balloon-shaped, hemispherical, part spherical, spherical cap or spherical segment-shaped. In some preferred embodiments the head may comprise a substantially spherical or balloon shape and the body may comprise a tubular, prismatic or channel shape, or a semi-tubular, semi-prismatic or semi-channel shape, such as a cylinder.

The head may comprise a beverage preparation machine steam conduit connector, arranged in use to receive a steam conduit of a beverage preparation machine. The steam conduit connector may comprise the opening of the steam inlet per se, which may be sized and/or configured to accept the outlet of a steam conduit of a beverage preparation machine, which may either coaxially enter or surround the opening of the wand steam inlet or abut the opening, for example.

The steam conduit connector may include sealing means (such as a seal), which may comprise a resilient sealing means, which in use is arranged to ensure no leakage of steam from the join between the steam conduit connector and a steam conduit of a beverage preparation machine, when joined.

The steam conduit connector may comprise a recess or depression formed at an upper end of the head, wherein the wand steam inlet is located within the recess or depression and wherein a beverage preparation machine steam conduit sealing means is located within the recess or depression, preferably around the periphery of the steam inlet.

In some embodiments the sealing means is a resilient sealing means and may comprise a resilient seal. The resilient seal may be an annular seal such as an annular gasket or O-ring. In this way, when the outlet of a steam conduit of a beverage preparation machine is received in the steam conduit connector of the steam wand head, it may pass through or around the resilient annular sealing means to connect to the wand steam inlet, and the resilience of the annular sealing means grips the join between the two components thereby preventing steam leakage and ensuring a robust connection between the components.

In some embodiments the sealing means is detachably mounted or mountable within the recess or depression. In such embodiments, the sealing means may be replaced or replaceable if it becomes damaged, or for hygiene reasons.

The head, the handle and/or body may comprise materials selected from metal, alloy, polymeric substrate such as polypropylene (PP), polyethylene (PE), polyethylene terephthalate (PET), polylactic acid (PLA), polyamide (PA), polycarbonate (PC), rubber, silicone and/or any combination thereof.

According to a fifth aspect of the invention there is provided a steam wand head comprising a steam inlet, a steam outlet and a steam conduit extending therebetween through the steam wand head, wherein the head further comprises a beverage preparation machine steam conduit connector, arranged in use to receive a steam conduit of a beverage preparation machine, and further comprising a beverage preparation machine steam conduit seal, arranged in use to prevent steam leakage from a connection between the wand steam inlet and beverage preparation machine steam conduit.

The steam conduit connector may comprise a recess or depression formed at an upper end of the head, wherein the steam inlet is located within the recess or depression and wherein a beverage preparation machine steam conduit seal is located within the recess or depression around the periphery of the steam inlet.

In some embodiments the seal is a resilient seal. The resilient seal may be an annular seal such as an annular gasket or O-ring. In this way, when a steam conduit of a beverage preparation machine is received in or around the steam conduit connector of the steam wand head, it passes through or around the resilient (annular) sealing means to connect with the steam inlet, and the resilience of the (annular) sealing means grips the join between the two components thereby preventing steam leakage and ensuring a robust connection between the components.

In some embodiments the seal is detachably mounted or mountable within the recess or depression. In such embodiments, the seal may be replaced or replaceable if it becomes damaged, or for hygiene reasons.

The steam inlet, steam outlet and steam conduit may be as described hereinabove for the steam wand of other aspects of the invention. The head may comprise a substantially spherical, balloon-shaped, hemispherical, spherical sector, spherical cap or funnel-shape, which may be as described hereinabove.

According to a sixth aspect of the invention there is provided a steam wand comprising a steam wand head of the fifth aspect of the invention.

The steam wand may comprise a body, as hereinabove described for other aspects of the invention.

According to a seventh aspect of the invention there is provided a beverage preparation machine comprising a steam wand of the sixth aspect of the invention.

### DETAILED DESCRIPTION OF THE INVENTION

In order that the invention may be more clearly understood, embodiments thereof will now be described, by way of example only, with reference to the accompanying drawings of which:

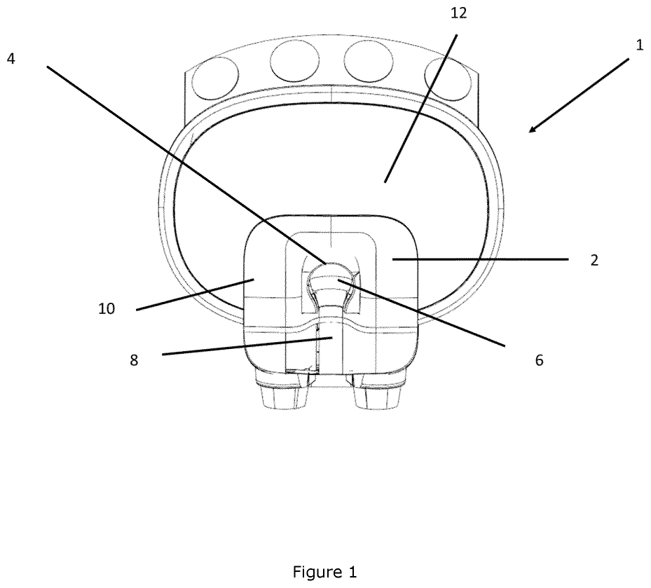

FIG. 1 illustrates a front view of a wand connector of a first embodiment of a beverage preparation machine according to the first aspect of the invention;

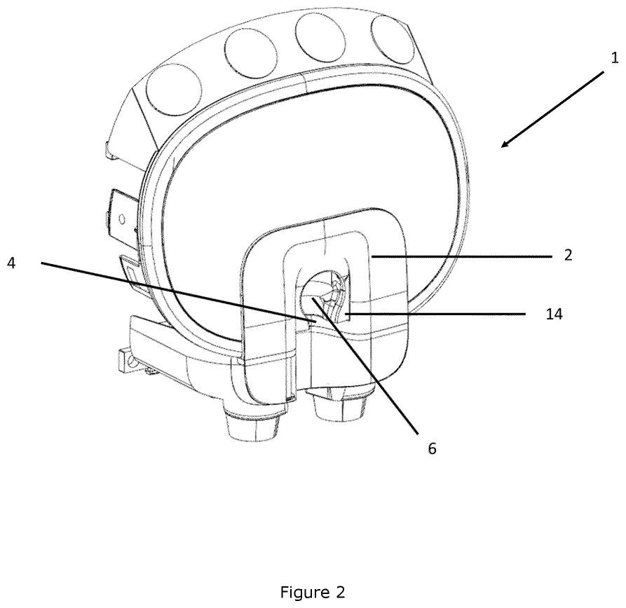

FIG. 2 illustrates a perspective view of the wand connector of FIG. 1;

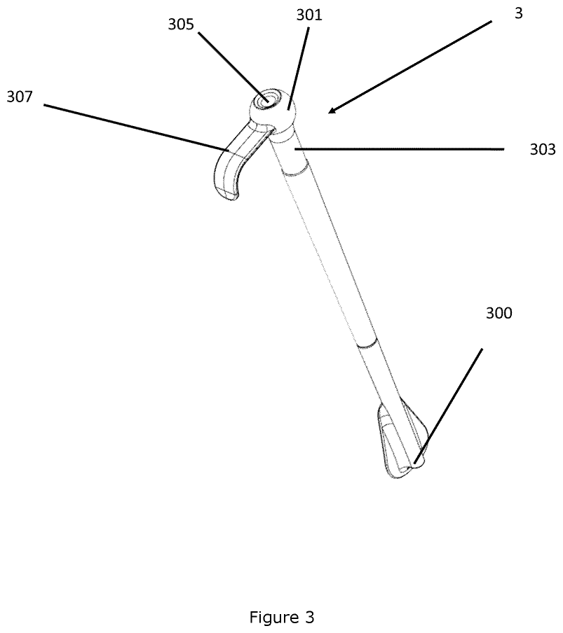

FIG. 3 illustrates a perspective view of an embodiment of a steam wand, according to the fourth aspect of the invention:

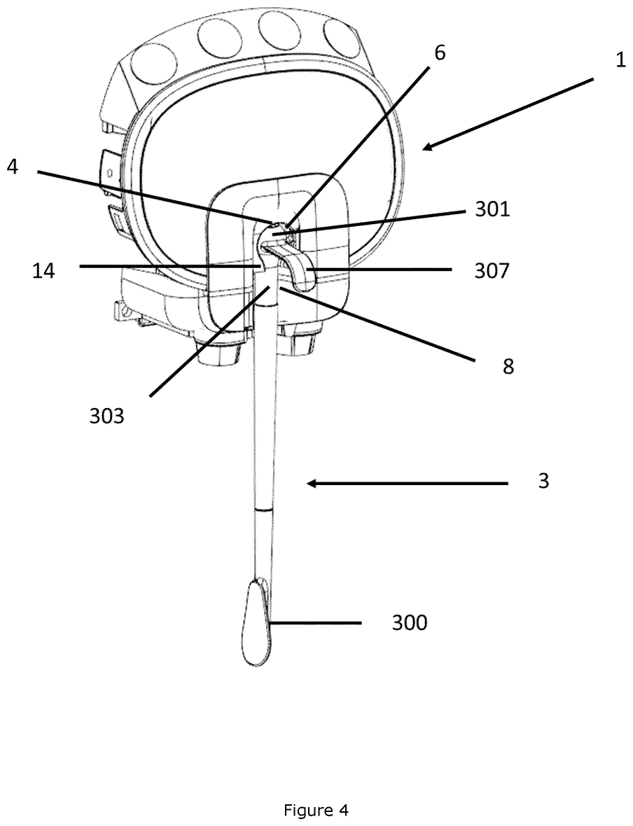

FIG. 4 illustrates a perspective view of an embodiment of a system according to the second aspect of the invention;

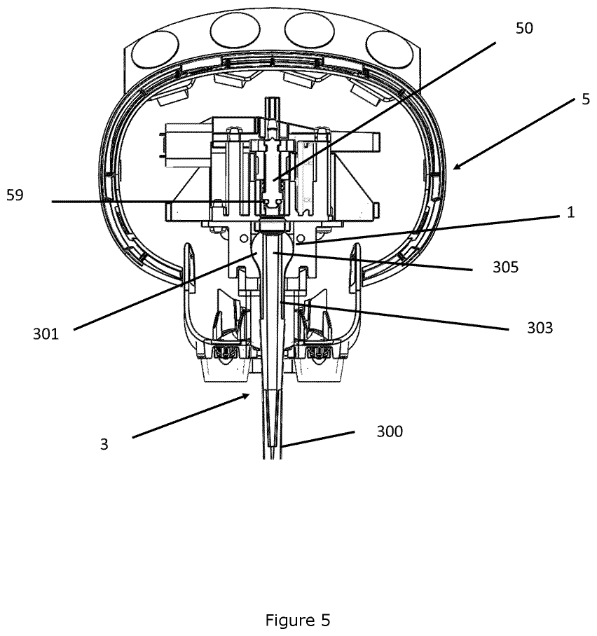

FIG. 5 illustrates a front cross-sectional view of the embodiment of the system of FIG. 4, in a rest position, according to the second aspect of the invention.

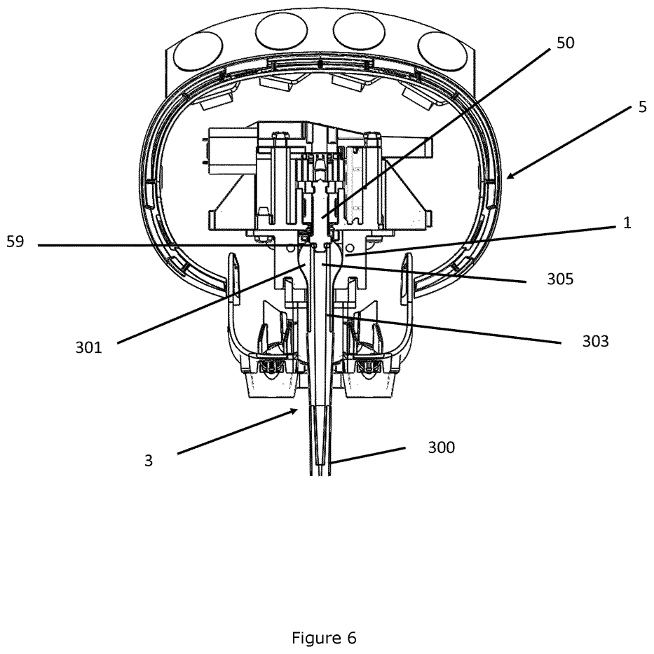

FIG. 6 illustrates a front cross-sectional view of the embodiment of the system of FIG. 5, in a working (operative) position, according to the second aspect of the invention.

Referring to the Figures, like numbers represent like components.

Referring firstly to FIGS. 1 and 2, a beverage preparation machine wand connector (1) connected to a beverage preparation machine faceplate (12) is shown. For simplicity's sake the remainder of the beverage preparation machine is not shown, but may be, for example, a coffee preparation machine.

The beverage preparation machine wand connector (1) comprises a steam wand connector plate (2) consisting of a steam wand connector aperture (4) which includes a first, upper (6) and a second, lower (8) connector portion, adjacent to and contiguous with each other. A steam wand connector plate peripheral wall (10) delimits said connector plate (2) within the beverage preparation machine faceplate (12).

The steam wand aperture (4) is set back in a pocket formed by upper, left and right sloping sides (13, 15, 17 respectively) within the connector plate (2). Said aperture (4) includes an entrance slot having the two superposed and adjacent portions (6, 8) in the form of two cavities which are in communication with each other. These two portions (6,8) have specific shapes which differ from each other. Particularly the first, upper portion (6) is a substantially balloon-shaped cavity which has a maximum width which tapers and/or curves to the second portion (8), which comprises a half-cylindrical shaped cavity and which has a narrower maximum width than the maximum width of the first portion (6). The first portion (6) comprises a cavity within the connector plate (2) having substantially balloon-shaped cross-sectional shape which tapers at its bottom towards the second portion (8) which comprises a cavity in the connector plate (2) having a slot-shaped cross-sectional shape, extending from said first portion (6) toward an outlet (not shown). The cross section of the overall aperture (4) leading to the cavities is substantially a keyhole shape, but other shapes are equally desirable, for example a funnel and/or tenon shape. The continuous cavity formed by the cavities of the first portion (6) and the second portion (8) is also keyhole-shaped in cross-section.

Referring to FIG. 3, a steam wand (3) according to the fourth aspect of the invention is shown.

Said steam wand (3) comprises a head (301), a body (303), a steam wand conduit (305) which extends through the head (301) and body (303), a handle (307) and a steam wand exit (300) which allows steam to exit the wand (3) into a beverage container, in use.

Said wand head (301) is wider than the body (303) and particularly the wand head (301) presents a maximum width which is greater than the maximum width of the body (303).

The wand head (301) has a substantially spherical shape, the bottom end of which tapers toward the contiguous wand body (303) which has a tubular (cylindrical) shape.

The steam wand conduit (305) comprises an inlet at the top thereof, which opens into a seat or depression (315) formed into the top of the wand head (301).

In some embodiments, the wand body (303) is integrally attached to the wand head (301). Alternatively, the body (303) can be removably attached to the wand head (301).

The assembly consisting of the head (301) and the body (303) can itself be removably attached or integrally connected to the rest of a steam wand (3) represented in FIG. 3.

The steam wand conduit (305) ensures fluid communication between the wand head (301) and the body (303) and extends through the entire length of the wand (3) down to the steam wand exit (300).

The handle (307) is positioned on the head (301), but in other embodiments can be positioned on the body (303). In other embodiments the handle may be omitted.

The steam wand head (301), the body (303) and the handle (307) can be made from materials such as metal, alloy, polymer substrates such as for instance polyethylene terephthalate (PET), polylactic acid (PLA), polyamide (PA), polycarbonate (PC), rubber, silicone and/or any combination thereof.

The head (301) and the body (303) are obtained through conventional manufacturing processes, such as moulding (for example 2-stage moulding and/or over-moulding), casting, extrusion.

Referring now to FIG. 4, a system comprising a beverage preparation machine connector (1) of FIGS. 1 and 2, and a steam wand (3) of FIG. 3 is shown.

The steam wand (3) is located in the beverage preparation machine connector (1) through the steam wand connector aperture (4). The circular cross-sectional shape of the entrance of the connector aperture first portion (6) matches the cross-sectional shape of the head (301) of the steam wand (3), allowing the insertion of the head (301) through the aperture (4). The width of the head (301) of the steam wand (3) is slightly smaller than the width of the first portion (6) of the connector (1). The substantially spherical head (301) fits within the cavity represented by the connector first portion (6) which matches the head's (301) shape.

The cross-sectional shape of the wand body (303) being slot-shaped, matches the cross-sectional shape of the second portion (8) of the aperture (4) and is slightly narrower than the second portion (8) so that it slots in the second portion (8) when correctly oriented.

The head (301) and body (303) therefore slot into the keyhole-shaped cavity of the aperture (4) formed by the substantially hemispherical first portion (6) and channel-shaped second portion (8). The head of the wand (301) being wider than the widest part of the channel-shaped second portion (8) of the connector plate (2), rests thereon preventing the wand (3) from dropping out of the aperture (4). In addition, because the head of the wand (301) is spherical and the first portion (6) of the aperture (4) of the connector plate (2) is also substantially circular in cross-section (and the cavity is substantially hemispherical), the head (301) can be inserted in multiple positions/orientations, and then rotated easily to align the body (303) with the channel-shaped second portion (8) of the aperture (4) for easy orientation and insertion. This enables a user to insert the wand (3) without carefully initially aligning the wand with the connector plate (2).

The handle (307) of the wand (3) is fixedly attached to the wand head (301) and allows an easy insertion of the wand (3) in the connector aperture (4), through the connector plate aperture (4).

In alternative embodiments the handle (307) may be positioned on the body (303) or there may be no handle (307).

In the embodiment of FIG. 4 the aperture (4) is in the form of a slot with a shape of a keyhole (leading to a cavity with a keyhole cross-sectional shape). In alternative embodiments the cross-sectional shape may be funnel, balloon or tenon shaped, for example.

In use, in order to form the system, the steam wand (3) is placed into the beverage preparation machine connector plate (2) by means of the handle (307). The head (301) of said wand (3) is inserted into the first portion (6) of the connector plate aperture (4) and then guided with the help of the handle (307) in such a way to position the body (303) of the wand (3) within the tubular second portion (8) of the connector plate (2). The handle (307) is then released and the wand drops into its final position within the cavity of the connector plate (2) by means of gravity.

FIGS. 5 and 6 illustrate a front cross-sectional view of the embodiment of the system of FIG. 4 comprising a beverage preparation machine connector (1) and a steam wand (3) in rest (FIG. 5) and working (or operative) (FIG. 6) positions.

FIG. 5 shows the beverage preparation machine connector (1) in a rest position with the steam wand (3) placed into the beverage preparation machine connector (1). The wand head (301), body (303) and wand steam conduit (305) extending therethrough are located beneath a steam source outlet (50) within the beverage preparation machine connector (1). A sealing means in the form of a gasket (59), i.e. an O-ring, is placed around the steam source outlet (50) to ensure a water-tight sealing of the system when in the working position.

In use, the steam wand (3) is placed into the beverage preparation machine connector (1) as described herein above in relation to FIG. 4, such that the system is in the rest position. In the rest position of FIG. 5, the conduit (305) of the wand (3) is disconnected from the steam source outlet (50) of the beverage preparation machine connector (1), as shown in FIG. 5. Once the beverage preparation machine (not shown) is turned on and a steam delivery is required for the frothing process, the steam source outlet (50) of the beverage preparation machine connector (1) is lowered towards the wand head (301) and engages with the conduit (305) of said wand (3), as shown in FIG. 6 (working position). The O-ring gasket (59) of the steam source outlet (50) then seals the periphery of the wand steam conduit (305), by deformation of the O-ring gasket (59) which enters the seat or depression (315) formed at the top of the wand head (301) and locates around the periphery of the steam conduit inlet of the wand steam conduit (305). The deformed O-ring gasket (59) resiliently grips the join between the steam source outlet (50) and wand steam conduit (305), ensuring steam cannot leak out. This ensures a watertight sealing of the wand (3) with the steam source outlet (50) of the beverage preparation machine whilst creating a continuous steam channel/conduit from the machine through the wand (3). Steam is then sent through the steam source outlet (50) to the wand exit (300) for the preparation of frothed beverages.

In some embodiments (not shown) a stiff silicone and/or rubber wand head (301) is particularly suitable to engage with the steam source outlet (50) of a beverage preparation machine, ensuring a watertight seal of the wand (3) to the beverage preparation machine connector (1), sealing the wand without need of any further gasket (for example an O-ring type gasket), reducing complexity and cost of the assembly mechanism of the beverage machine itself.

In other alternative embodiments (not shown), a sealing means in the form of, for example, a resilient O-ring is placed on the top of the steam wand head (301), at the entrance of the steam wand conduit (305) in the recess or depression (315) formed at the top of the steam wand head (301), rather than on the steam source outlet of the beverage preparation machine, to ensure sealing once the conduit (305) inlet engages the steam source outlet (50) of a beverage preparation machine, deforming the O-ring within the recess or depression (315), which resiliently grips the steam source outlet (50) and the join between the steam source outlet (50) and conduit inlet, ensuring steam cannot leak out. One of the advantages of these alternative embodiments in which the sealing means (the O-ring) is positioned on the head of the steam wand (301) is that the sealing means can be easily replaced if deteriorated by use, without requiring access to the inside of the beverage preparation machine.

The above embodiments are described by way of example only. Many variations are possible without departing from the scope of the invention as defined in the appended claims.

1: A beverage preparation machine comprising a steam wand connector wherein the connector comprises an aperture having a first portion having a first maximum width which tapers and/or curves to a second portion which has a second narrower width.

2: A beverage preparation machine according to claim 1 wherein said first portion is circular, balloon-shaped, semi-circular, circular sector, circular cap or funnel-shaped in cross-section.

3: A beverage preparation machine according to claim 1 wherein said second portion has a tubular or channel cross-section.

4: A beverage preparation machine according to claim 1 wherein the second portion extends below said first portion.

5: A beverage preparation machine according to claim 1 wherein said aperture of said connector is directly or indirectly in fluid communication with a steam source of the beverage preparation machine.

6: A beverage preparation machine according to claim 1 wherein said aperture comprises a slot or cavity.

7: A beverage preparation machine according to claim 6 wherein said slot comprises a keyhole shape or said cavity comprises a keyhole cross-sectional shape.

8: A beverage preparation machine according to claim 1 wherein the connector comprises a connector plate and said aperture is set back in a pocket or depression formed in said connector plate.

9: A beverage preparation machine according to claim 8 wherein said connector plate is arranged on a front face of said beverage preparation machine.

10: A system comprising a beverage preparation machine according to claim 1 and a steam wand wherein the steam wand comprises a head and body, wherein the head is wider than the body and wherein a steam conduit extends through the head and body of said steam wand.

11: A system according to claim 10 wherein the width of said head is smaller than the width of the first portion of the connector, but wider than the width of the second portion, and wherein the width of said body is smaller than the width of the second portion of the connector.

12: A system according to claim 10 wherein said head comprises a spherical, hemispherical, balloon-shape, spherical cap, spherical segment or funnel-shape.

13: A system according to claim 10 wherein said head is integrally attached or detachable from said body.

14: A system according to claim 10 wherein said steam wand further comprises a handle.

15: A system according to claim 10, wherein the width of the body of the steam wand is no more than 75% of the width of the head of the steam wand.

16: A method of attaching a steam wand to a beverage preparation machine according to claim 1 comprising the steps of:
providing a steam wand having a head and body, wherein the head is wider than the body and wherein a steam conduit extends through the head and body of said steam wand;
introducing the steam wand head into the first portion of the beverage preparation machine connector aperture;
orienting the wand body into the second portion of the beverage preparation machine connector aperture.

17: A steam wand comprising a head having a first maximum width which tapers and/or curves to a body which has a second narrower width.

18: A steam wand according to claim 17 wherein said head comprises a spherical, balloon, hemispherical, spherical sector, spherical cap or funnel shape and said body comprises a tubular, prismatic or channel shape, such as a half-cylinder shape.

19: A steam wand according to claim 17 wherein said head comprises a beverage preparation machine steam conduit connector comprising a beverage preparation machine steam conduit sealing means.

20: A steam wand according to claim 19 wherein said sealing means comprises a resilient sealing means.

21: A steam wand according to claim 20 wherein said resilient sealing means comprises a rubber or silicone seal.

22: A steam wand according to claim 19 wherein said sealing means comprises an O-ring.

23: A steam wand according to claim 19 wherein said sealing means comprises a removable sealing means.

24: A steam wand head comprising a steam inlet, a steam outlet and a steam conduit extending therebetween through the steam wand head, wherein the head further comprises a beverage preparation machine steam conduit connector, arranged in use to receive a steam conduit of a beverage preparation machine, the connector comprising a recess or depression formed at an upper end of the head, wherein the steam inlet is located within the recess or depression and wherein a beverage preparation machine steam conduit sealing means is located within the recess or depression around the periphery of the steam inlet.
